(19) United States
(12) Patent Application Publication
(10) Pub. No.: US 2006/0018478 A1
(43) Pub. Date: Jan. 26, 2006

(54) Secure communication protocol

(76) Inventors: Kristopher G. Diefenderfer, Centreville, VA (US); Peter David Lovell, Rockville, MD (US); Daniel Bailey Bezilla, Philipsburg, PA (US)

Correspondence Address: HARNESS, DICKEY & PIERCE, P.L.C., P.O. BOX 8910, RESTON, VA, 20195, US

(21) Appl. No.: 10/963,766

(22) Filed: Oct. 14, 2004

Related U.S. Application Data
(63) Continuation-in-part of application No. 10/897,399, filed on Jul. 23, 2004.
(63) Continuation-in-part of application No. 10/944,406, filed on Sep. 20, 2004.
(63) Continuation-in-part of application No. 10/897,402, filed on Jul. 23, 2004.
(63) Continuation-in-part of application No. 10/933,504, filed on Sep. 3, 2004.
(63) Continuation-in-part of application No. 10/933,505, filed on Sep. 3, 2004.

(51) Int. Cl. H04L 9/00

(52) U.S. Cl. 380/259

(57) ABSTRACT

A method, of establishing secure communication, may include: generating a first symmetric key; encrypting at least the first symmetric key according to a public key; sending a first message that includes at least the encrypted first symmetric key to a communication counterpart using a connectionless protocol; and receiving, as part of a connection-oriented-protocol first session, a second message that includes an acknowledgement encrypted via the first symmetric key. A counterpart method may include: receiving and decrypting the first message according to the corresponding private key; and encrypting and then sending the second message. Another such method may include: encrypting a chunk of information according to a first symmetric key, the first symmetric key having been used in a previous and now-stopped connection-oriented session with a communication counterpart; and sending to a communication counterpart a first message whose payload at least in part the encrypted chunk of information.

### CONTINUITY AND PRIORITY

This application is a continuation in part of the following copending U.S. patent applications (hereafter, parent applications): Ser. No. 10/897,399, filed Jul. 23, 2004; Ser. No. 10/944,406, filed Sep. 20, 2004; Ser. No. 10/897,402, filed Jul. 23, 2004; Ser. No. 10/933,504, filed Sep. 3, 2004; and Ser. No. 10/933,505, filed Sep. 3, 2004. The entirety of each of the above-identified parent applications is hereby incorporated by reference. And priority upon each of the above-identified parent applications is claimed under 35 U.S.C. §120.

### BACKGROUND OF THE PRESENT INVENTION

Attacks on computer infrastructures are a serious problem, one that has grown directly in proportion to the growth of the Internet itself. Most deployed computer systems are vulnerable to attack. The field of remediation addresses such vulnerabilities and should be understood as including the taking of deliberate precautionary measures to improve the reliability, availability, and survivability of computer-based assets and/or infrastructures, particularly with regard to specific known vulnerabilities and threats.

A remediation system architecture according to the Background Art treats computing assets of a network, e.g., servers, workstations and personal computers (PCs) that communicate over the network, as host-assets. Onto each host-asset is loaded a software agent. Each software agent typically can do at least the following: receive a remediation of some type from a remediation server; and facilitate implementation of the remediation upon the host-asset.

Efforts have been made to ensure that communication between the remediation server and a software agent is relatively secure. An example of a secure communication protocol according to the Background Art is the Secure Sockets Layer (SSL).

### SUMMARY OF THE PRESENT INVENTION

At least one embodiment of the present invention provides a method of establishing secure communication. Such a method may include: generating a first symmetric key; encrypting at least the first symmetric key according to a public key; sending a first message that includes at least the encrypted first symmetric key to a communication counterpart using a connectionless protocol; and receiving, as part of a connection-oriented-protocol first session, a second message that includes an acknowledgement that the counterpart received the first message, the acknowledgement being encrypted via the first symmetric key.

At least one other embodiment of the present invention provides a method of establishing secure communication. Such a method may include: receiving a first message that was sent using a connectionless protocol from a communication counterpart, the first message including at least a first symmetric key that has been encrypted according to a public key, there being a private key counterpart thereto; decrypting the first message according to the private key to obtain at least the first symmetric key; encrypting an acknowledgement of having received the first message according to the first symmetric key; and sending, as part of a first connection-oriented-protocol session, a second message that includes the encrypted acknowledgement to the counterpart.

At least one other embodiment of the present invention provides a method of establishing secure communication. Such a method may include: encrypting a chunk of information according to a first symmetric key, the first symmetric key having been used in a previous and now-stopped connection-oriented session with a communication counterpart; and sending a first message to a communication counterpart, the first message having a payload at least a portion of which includes the encrypted chunk of information.

At least one other embodiment of the present invention provides a machine-readable medium comprising instructions, execution of which by a machine facilitates establishing secure communication, as in any one or more of the methods mentioned above. At least one other embodiment of the present invention provides a machine configured to implement any one or more of the methods mentioned above.

Additional features and advantages of the present invention will be more fully apparent from the following detailed description of example embodiments, the accompanying drawings and the associated claims.

### BRIEF DESCRIPTION OF THE DRAWINGS

The drawings are: intended to depict example embodiments of the present invention and should not be interpreted to limit the scope thereof. In particular, relative sizes of the components of a figure may be reduced or exaggerated for clarity. In other words, the figures are not drawn to scale.

FIG. 1 is a block diagram of an architecture for a policy-based remediation system into which embodiments of the present invention can be incorporated, making this system itself represent at least one embodiment of the present invention.

FIG. 2 is a version of the block diagram FIG. 1 that is simplified in some respects and more detailed in others, according to at least one embodiment of the present invention.

FIGS. 3A, 3B and 3C are UML-type sequence diagrams depicting methods of facilitating secure communication, according to at least some of the embodiments of the present invention. In a sequence diagram,

[symbol]

indicates an action that expects a response message. A

[symbol]

indicates a response (responsive action). A

[symbol]

indicates an action for which the response is implied. And a

[symbol]

indicates an action for which no response is expected.

### DETAILED DESCRIPTION OF EXAMPLE EMBODIMENTS

In developing the present invention, the following problems with the Background Art were recognized and a path to a solution identified.

A malefactor wishing to compromise SSL (again, Secure Sockets Layer) can exploit its repetitive nature. SSL uses TCP (transmission control protocol) sessions. At the start of each session, the initiator (e.g., a software agent) encrypts and then sends a symmetric key using the public key of its intended recipient (or, in other words, the communication counterpart, e.g., the remediation server). The counterpart decrypts the symmetric key using its corresponding private key. Then all further communication in that session is encrypted with the symmetric key. Each session with the remediation server started by a software agent will use a different symmetric key, but will always start by encrypting the symmetric key using the same public key. If a malefactor can obtain and break the initiator's public key, then the malefactor can eavesdrop, etc., on any subsequent session because the malefactor can decode the symmetric keys for those subsequent sessions.

Breaking a public key is not done easily. Typical computational ability available today can require 2-3 months to crack a 512 byte public key. Replacing public & private key pairs at an interval smaller than the typical minimum cracking time (T_{CRACK}^{MIN}) can reduce vulnerability. But as computational power inevitably increases, the typical T_{CRACK}^{MIN} will decrease. Eventually, the interval of replacing public & private key pairs will become so small as to be burdensome.

Also, exploiting SSL via cracking a public key presumes that fairly regular sessions occur between the holder of the public key and the holder of the private key. In many circumstances, that presumption is not true. But in the circumstance, e.g., of remediation system, that presumption is true.

A secure communication protocol that does not repeatedly use (or better rarely uses) a public key would be less susceptible to a malefactor that has cracked the public key. At least one embodiment of the present invention provides a secure communication protocol that is less susceptible to a cracked public key by virtue of rarely using the public key.

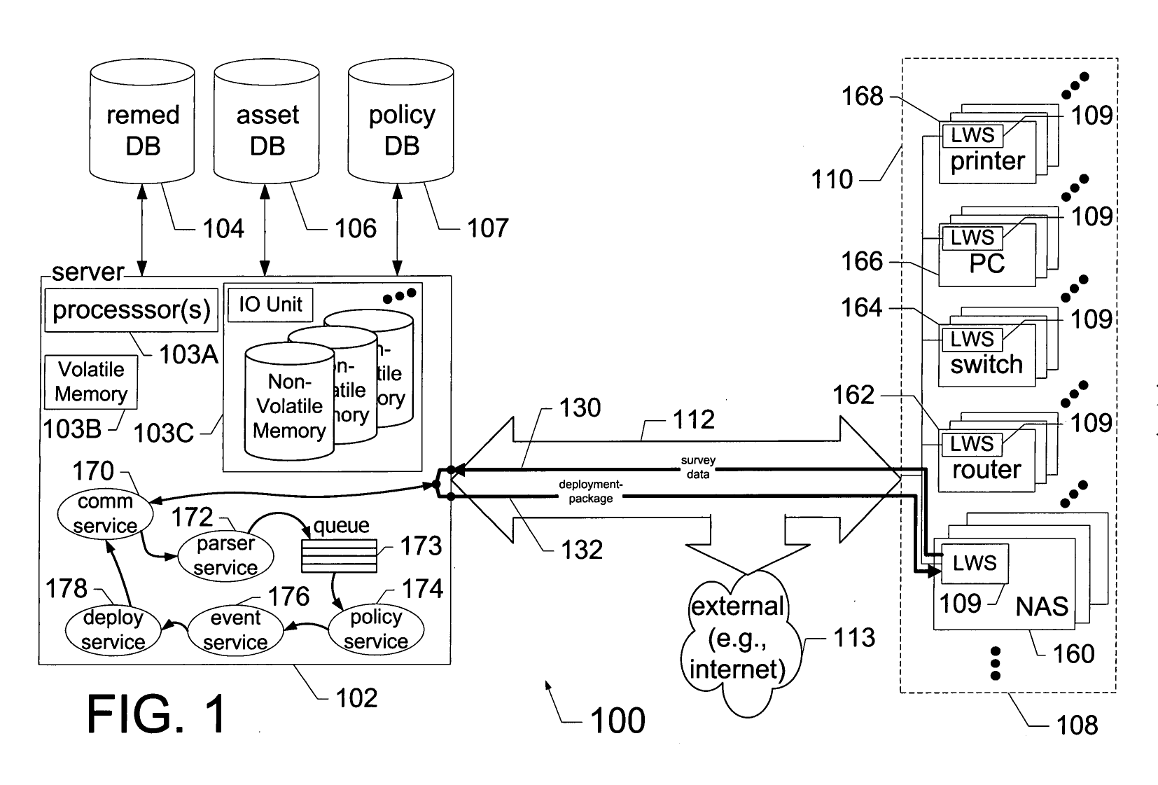

FIG. 1 is a block diagram of an architecture 100 for remediation system, e.g., a policy-based remediation system, into which embodiments of the present invention can be incorporated. Architecture 100 provides a helpful context in which to discuss embodiments of the present invention. The incorporation of such embodiments into architecture 100 makes architecture 100 itself represent at least one embodiment of the present invention.

Architecture 100 can include: a server 102 (having one or more processors 103, non-volatile memory 103B and other components 103C); a database (DB) of remediations 104; a DB of assets 106; a DB of policies 106; and a group 108 of networked assets. Generalized networked communication is represented by path 112. Access to entities external to architecture 100, e.g., the internet (item 113) is available via path 112.

Server 102 can be a component of the network to which group 108 represents assets. Other components 103B typically include an input/output (IO) unit, volatile memory (e.g., RAM, etc.), non-volatile memory (e.g., disk drives, etc.), etc. DBs 104,106 and 107 can be local non-volatile memory resources of server 102.

Examples of assets in group 108 include network-attached storage (NAS) devices 160, routers 162, switches 164, computers (also referred to as PCs) 166, printers 168, wireless telephones (not depicted) with our without email capability, wireless PDAs (not depicted) with our without email capability, etc. Assets in group 108 will be generally be referred to as host-assets 16X. In group 108, host-assets 16X can be characterized as devices having some measure of program-code-based operation, e.g., software, firmware, etc., which can be manipulated in some way via an instance of a communication, e.g., arriving via path 112, and as such can be vulnerable to attack.

Each of the various host-assets 16X in group 108 is depicted as hosting a software agent, here referred to as a light weight sensor (LWS) 109. Each LWS 109 and server 102 adopt a client-server relationship. Operation of each LWS 109 can include gathering information about its host-asset 16X and sending such information to server 102; and receiving remediations in an automatically-machine-actionable format from server 102 and automatically implementing the remediations upon its host-asset 16X.

An automatically-machine-actionable remediation can take the form of a sequence of one or more operations that automatically can be carried out on a given host-asset 16X under the control of its LWS 109. Such operations can be invoked by one or more machine-language commands, e.g., one or more Java byte codes.

Server 102 can evaluate the gathered-information regarding host-assets 16X, e.g., in terms of policies that have been applied, or are active in regard to, host-assets 16X, respectively. Based upon the evaluations, server 102 can select remediations and then send them to host-assets 16X, respectively.

Each host-asset 16X is provided with one or more local programs and/or services (hereafter, survey-tools) that can collect values of a plurality of parameters (hereafter, survey data) which collectively characterize an operational state of host-asset 16X at a particular point in time. Each LWS 109 can invoke such survey-tools and/or cooperate with periodic scheduling of such survey-tools to obtain the survey data. Then each LWS 109 can also transmit the survey data to server 102.

For example, consider LWS 109 of NAS 160, whose transmission of survey data to server 102 is indicated by a communication path 130 superimposed on path 112 in FIG. 1. Continuing the example, once server 102 has selected one or more remediations for NAS 160, server 102 deploys the selected remediation(s) to LWS 109 of NAS 160 as indicated by a communication path 132. The selected remediations can take the form of a deployment package that can include one or more automatically-machine-actionable actions, e.g., a set of one or more Java byte codes for each automatically-machine-actionable action. It is noted that, for simplicity of illustration, only NAS 160 is depicted in FIG. 1 as sending survey data and receiving a deployment package. It is to be understood that instances of paths 130 and 132 would be present for all instances of LWS 109.

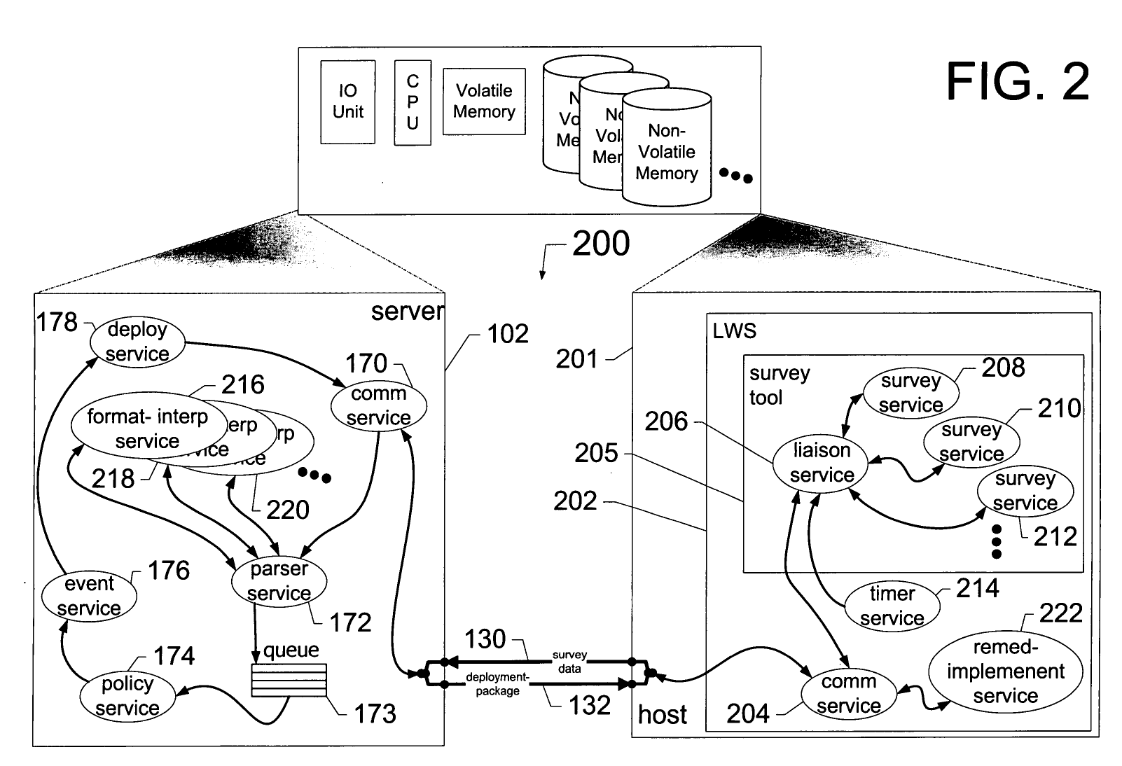

FIG. 2 is a version of the block diagram FIG. 1 that is simplified in some respects and more detailed in others. As such, FIG. 2 depicts an architecture 200, according to at least one embodiment of the present invention.

In architecture 200, only one host-asset 201 from group 108 of host-assets 16X is depicted, for simplicity. For example, host-asset 201 can correspond to NAS 160. The LWS corresponding to host-asset 201 is given item no. 202.

In FIG. 2, LWS 202 can include: a communication service 204; a timer service; a remediation-implementation service 222; and at least one survey-tool 205.

Typical hardware components for host 201 and server 102 (again) are shown in an exploded view in FIG. 2. Such components can include: a CPU/controller, an I/O unit, volatile memory such as RAM and non-volatile memory media such disk drives and/or tape drives, ROM, flash memory, etc.

Survey-tool 205 can be a service of LWS 202. For simplicity of discussion, survey-tool 206 has been depicted as including: a liaison service 206; and survey services 208, 210, 212, etc. The number of survey services can be as few as one, or greater than the three depicted. Alternatively, survey-tool 205 can be an application program separate from LWS 202 and yet loaded on host-entity 201. Further in the alternative, where survey-tool 205 is a separate application, liaison service 206 could be a part of LWS 202 instead of a part of survey-tool 205.

Also in FIG. 2, server 102 includes: a communication service 170 (e.g., comparable, and a counterpart, to communication service 204); a parser service 172; a queue 173; a policy service 174; an event service 176; a deployment service 178; and format-interpretation (FI) services 216, 218, 220, etc. Services 170-178 and queue 173 can cooperate to evaluate the survey data according to policies and to responsively assemble deployment packages. Communication services 204 and 170 can be, e.g., J2EE-type services.

FI-services 216-220 correspond and accommodate foreign data-formats used by survey services 208-210. It should be understood, however, that there is likely to be other foreign data-formats used by other survey services on other ones of host-assets 16X. Hence, there is likely to be a greater number of FI-services on server 102 than there are survey services on any one of host-assets 16X.

Survey data can be gathered, e.g., periodically, from LWS 202. Timer service 214 can control when such gathering occurs. For example, timer service 214 can monitor time elapsed since the most recent gathering/sampling of data and can trigger survey-tool 205 to re-survey when an elapsed time equals a sampling interval.

Survey data from LWS 202 (which is transferred via path 130) can be formatted in a variety of ways. For example, LWS can transfer a block of data. Within the block, chunks of data representing particular parameters can be associated with (e.g., preceded by) service-keys, respectively. For example, a service-key can be a string of data, e.g., a 32 bit integer, that denotes or is indicative of the service on host-asset 201 that gathered the chunk. Parser service 172, e.g., a J2EE-type service, can parse the data block by making use of FI-services 216-220, respectively.

Survey data can be transferred from liaison service 206 to parser service 172 via communication services 204 and 170 over path 130. Deployment packages containing remediations can be transferred from deployment service 178 to remediation-implementation server 222 via communication services 170 and 204 over path 132.

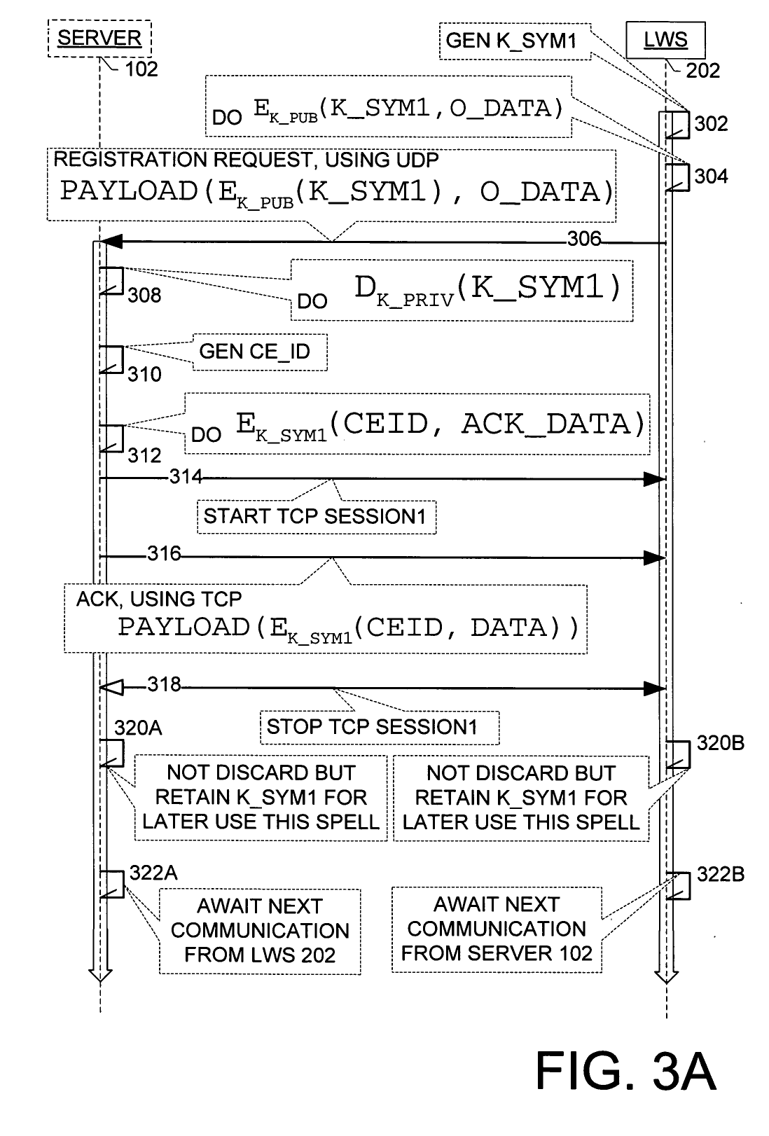

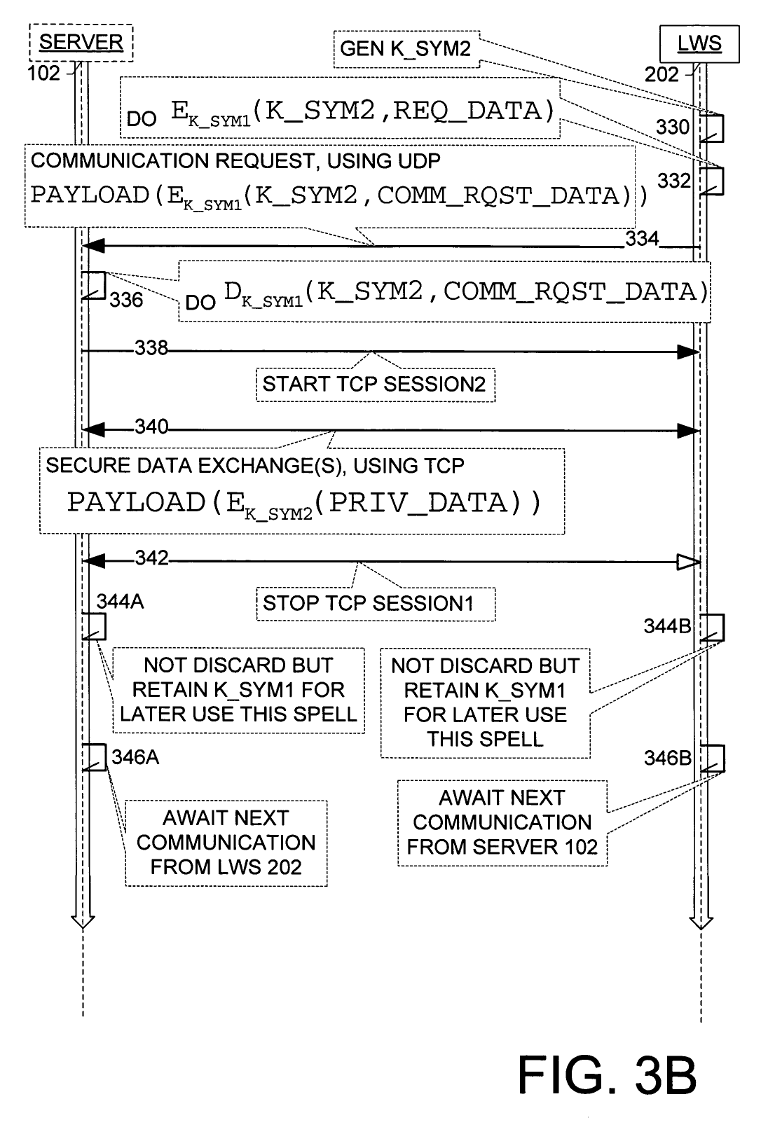

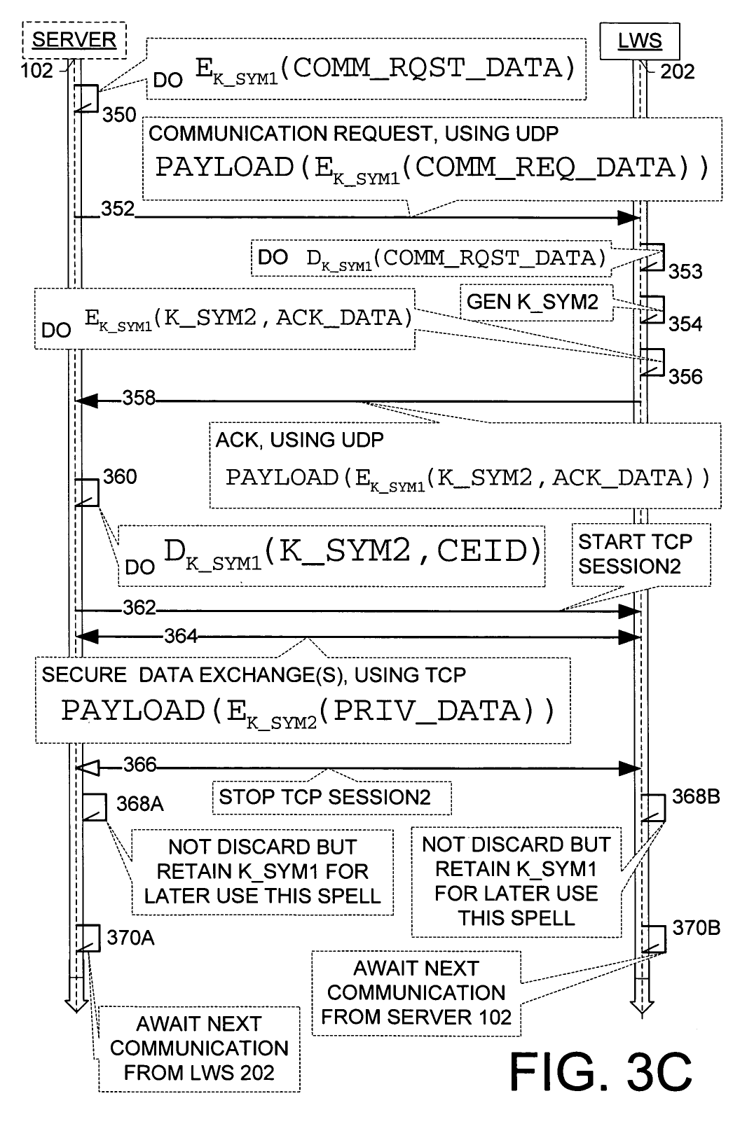

Such communications should be secure to frustrate efforts of a malefactor to attack system 200/100. A secure communication protocol that can be used by LWS 202 and server 102, e.g., more particularly by communication services 204 and 170, respectively, will now be discussed with reference to FIGS. 3A-3C.

FIGS. 3A, 3B and 3C are UML-type sequence diagrams depicting methods of facilitating secure communication (or, in other words, depicting secure communication protocols), according to embodiments of the present invention.

FIG. 3A concerns an original registration of LWS 202 with server 102. Typically, this represents the first communication between these two entities. To make it more difficult for a malefactor to obtain the public key of server 102, server 102 is not configured to provide its public key when a communication counterpart requests it. Rather, the counterpart must obtain the public in some other manner, e.g., by an administrator of the network manually storing it on the counterpart. In the context of architecture 200, it is assumed that the administrator already has stored the public key of server 102 in non-volatile memory available to LWS 202.

LWS 202 can register originally with server 102, e.g., as follows. In FIG. 3A, LWS 202 can generate a first symmetric key K_SYM1 at self-action 302. Also at action 302, LWS 202 can store K_SYM1 in volatile memory, e.g., RAM. It is assumed that host-entity 201 potentially presents a hostile environment toward LWS 202. Accordingly, for greater security of K_SYM1, LWS 202 can store K_SYM1 only in volatile memory. That is, K_SYM1 would not also be stored in non-volatile memory, e.g., hard-disk space to which LWS 202 has access.

At self-action 304, LWS 202 can encrypt K_SYM1, and optionally other data (O_DATA), according to the public key (K_PUB) of server 102, namely
E_{K}_{_{—}}_{PUB}(K_SYM1, O_DATA) 1)

At action 306, LWS 202 can send (e.g., via communication services 204 and 170) a registration request message to server 102. The encrypted K_SYM2 (and the optional O_DATA) can comprise at least a portion of the payload of the registration request message. Alternatively, the registration request message can omit the O_DATA, or can include the other data O_DATA albeit not encrypted according to K_PUB. To reduce the degree to which a malefactor can sniff for the registration request message of action 306, it can be sent using a connectionless protocol, e.g., UDP (user datagram protocol). At self-action 308, server 102 can decrypt K_SYM1 according to its corresponding private key K_PRIV, namely
D_{K}_{_{—}}_{PRIV}(K_SYM1, DATA) 2)

At self-action 310, server 102 can generate a CE_ID, where CE_ID is a term for an identification (ID) of a given LWS 109 loaded on a given host-asset 16X, and where each instance of a host-asset 16X can be described as a client environment (CE). At self-action 312, server 102 can encrypt the CE_ID, and other data (ACK_DATA) indicative of an acknowledgement that the request was received, namely
E_{K}_{_{—}}_{SYM1}(CEID, ACK_DATA) 3)

At action 314, server 102 can initiate a first connection-oriented communication session using, e.g., TCP (again, transmission control protocol), with LWS 202 (e.g., via communication services 170 and 204). At action 316, server 102 can acknowledge the registration request by sending a message. The payload of such an acknowledgement message can include at least the encrypted CE_ID and the encrypted ACK_DATA obtained previously at self-action 312. Alternatively, the CE_ID can be encrypted without also encrypting the ACK_DATA, or the ACK_DATA can be omitted. As will be discussed later, LWS 202 can store, in non-volatile memory, CE_ID and/or the version of CE_ID encrypted according to K_SYM1.

After the acknowledgement message of action 316 is received, server 102 can terminate the first TCP session at action 318. Alternatively, the first TCP session can be terminated by LWS 202. Such an alternative is depicted in FIG. 3A via the line representing action 318 having an open-headed arrow

[symbol]

pointing to server 102 in addition to a solid-head arrow

[symbol]

pointing to LWS 202.

After the first TCP session is terminated, each of server 102 and LWS 202 should retain K_SYM1 for later use during the current spell. A layman understands a spell as a period of indeterminate length marked by some action or condition. Here, a spell should be understood as the continuous length of time between when LWS 202 boots-up and when it is either rebooted or shut down, or it loses power, etc. As noted above, to enhance security, LWS 202 stores K_SYM1 in volatile memory but not in non-volatile memory. When the current spell ends due to rebooting, being shut down, power loss, etc., then K_SYM1 is lost to LWS 202.

To facilitate the description, a contrast will now be drawn with the Background Art. When a Background Art TCP session ends, the symmetric key is discarded. Typically, the memory allocated to the symmetric key is deallocated, which effectively prevents further use of the symmetric key. At action 320B, however, LWS 202 can retain K_SYM1 for later use during the current spell by not deallocating the volatile memory that has been allocated to K_SYM1. Similarly, at action 320A, server 102 can retain K_SM1 or later use during the current spell by not deallocating the volatile memory that has been allocated to K_SYM1. While it is assumed that host-entity 201 potentially presents a hostile environment for LWS 202, the entity (not shown) hosting server 102 is not assumed to be hostile toward server 102, so server 102 can store K_SYM1 in volatile memory and/or non-volatile memory. Because server 102 can store K_SYM1 in non-volatile memory, the term, spell, is not used to describe the operation of server 102.

Self-actions 320A and 320B can occur substantially simultaneously. Hence they have been assigned the same reference number albeit with the different suffixes -A and -B. Similarly, an imaginary horizontal line would connect the origin of the arrows represent self-actions 320A and 320B. Alternatively, one of self-actions 320A and 320B could occur before the other.

After having not discarded K_SYM1, each of server 102 and LWS 202 can then stay alive waiting for the next communication from the other (if that arises at all), as indicated by self-actions 322A and 322B. Like self-actions 320A & 320B, self-actions 322A & 322B can occur substantially simultaneously, etc.

FIG. 3B concerns post-registration communication initiated by LWS 202 with server 102 during the same spell in which registration (see FIG. 3A) occurred.

In FIG. 3B, at self-action 330, LWS 202 can generate a second symmetric key K_SYM2. For each session following the first (or, in other words, the original registration) session of FIG. 3A, LWS 202 can generate a different symmetric key. Here, for simplicity, the discussion assumes that the session of FIG. 3B is the second session, hence the second symmetric key is only now being generated. But it is to be understood that FIG. 3B can also represent what occurs for the third, fourth, fifth, etc. session so long as the session occurs within the same spell as the original registration session (see FIG. 3A).

Also at self-action 330, LWS 202 also can store K_SYM2 in volatile memory in order to obtain a higher level of security for K_SYM2 than is afforded otherwise by storage in non-volatile memory. Again this can be done because host-entity 201 potentially presents a hostile environment toward LWS 202.

At self-action 332, LWS 202 can encrypt K_SYM2, and optionally any data (COMM_RQST_DATA) that might be associated with requesting a communication session, according to K_SYM1, namely
E_{K}_{_{—}}_{SYM1}(K_SYM2, COMM_RQST_DATA) 4)
It is to be recalled that K_SYM1 was retained (or, in other words, not deallocated from volatile memory) by LWS 202 previously at self-action 320B.

At action 334, LWS 202 can send (e.g., via communication services 204 and 170) a communication request message to server 102. The encrypted versions of K_SYM2 and COMM_RQST_DATA can comprise at least a portion of the payload of the communication request message. Alternatively, the communication request message can omit the COMM_RQST_DATA, or can include the COMM_RQST_DATA albeit not be encrypted according to K_SYM1. To reduce the degree to which a malefactor can sniff for the communication request message of action 334, it can be sent using a connectionless protocol, e.g., UDP (user datagram protocol).

At self-action 336, server 102 can decrypt K_SYM2 (and the COMM_RQST_DATA if present and encrypted) according to K_SYM1, namely
D_{K}_{_{—}}_{SYM1}(K_SYM2, COMM_RQST_DATA) 5)
It is to be recalled that K_SYM1 was retained by server 102 previously at self-action 320B.

At action 338, server 102 can initiate a second connection-oriented communication session using, e.g., TCP, with LWS 202 (e.g., via communication services 170 and 204). At action 340, server 102 and LWS 202 can securely exchange one or more messages whose payloads include various different instances of private data (PRIV_DATA), as part of the second session using TCP. Such PRIV_DATA is encrypted by either of LWS 202 or server 102 using K_SYM2, namely
E_{K}_{_{—}}_{SYM2}(PRIV_DATA) 6)
Correspondingly, the other of LWS 202 and server 102 can decrypt the payload of the message using K_SYM2, namely
D_{K}_{_{—}}_{SYM2}(PRIV_DATA) 7)

It should be noted that action 340 in FIG. 3B can represent one or more actions that comprise the secure exchange of one or more different instances of PRIV_DATA. Accordingly, instead of depicting action 340 via a line having one solid arrowhead

[symbol]

that points away from the initiator of the action, the line depicting action 340 has two solid arrowheads

[symbol]

to show that there can be one or more actions denoted by reference No. 340 and that the one or more actions can be initiated by one or both, respectively, of LWS 202 and server 102.

After the one or more messages of action 340 are exchanged, LWS 202 can terminate the second session at action 342. Alternatively, the second TCP session can be terminated by server 102. Such an alternative is depicted in FIG. 3A via the line representing action 342 having an open-headed arrow

[symbol]

pointing to LWS 202 in addition to a solid-head arrow

[symbol]

pointing to server 102.

After the second TCP session is terminated, each of server 102 and LWS 202 should retain K_SYM1 for later use during the current spell, as indicated by self-actions 344A and 344B, respectively. After yet again not having discarded K_SYM1, each of server 102 and LWS 202 can then stay alive waiting for the next communication from the other (if that arises at all), as indicated by self-actions 346A and 346B. Like self-actions 320A & 320B, self-actions 344A & 344B and self-actions 346A & 346B can occur substantially simultaneously, etc., respectively.

FIG. 3C concerns post-registration communication initiated by server 102 with LWS 202 during the same spell in which registration (see FIG. 3A) occurred. FIG. 3C could occur before and/or after FIG. 3B.

In FIG. 3C, at self-action 350, server 102 can encrypt an instance of communication request data (COMM_RQST_DATA), receipt of which by a counterpart, e.g., LWS 202, is understood as a request to establish a communication session. Such a session follows the first session of FIG. 3A. Here, for simplicity, the discussion assumes that the inchoate request of self-action 350 will result in a second session, for which (again) LWS 202 will generate a different symmetric key. But, as with FIG. 3B, it is to be understood that FIG. 3C can also represent what occurs for the third, fourth, fifth, etc. session so long as the session occurs within the same spell as the original registration session (see FIG. 3A).

The encryption of self-action 350 is performed according to K_SYM1, namely
E_{K}_{_{—}}_{SYM1}(COMM_RQST_DATA) 8)
It is to be recalled that K_SYM1 was retained by server 102 previously at self-action 320A.

At action 352, server 102 can send (e.g., via communication services 170 and 204) a communication request message to LWS 202. The encrypted version of COMM_RQST_DATA can comprise at least a portion of the payload of the communication request message. Alternatively, the registration request message can include the COMM_RQST_DATA albeit not be encrypted according to K_SYM1. To reduce the degree to which a malefactor can sniff for the communication request message of action 352, it can be sent using a connectionless protocol, e.g., UDP (user datagram protocol).

At self-action 353, LWS 202 can decrypt the COMM_RQST_DATA according to K_SYM1, namely
D_{K}_{_{—}}_{SYM1}(COMM_RQST_DATA) 9)
It is to be recalled that K_SYM1 was retained by LWS 202 previously at self-action 320B. As a new session is to be started, LWS 202 should generate a different (here, second) symmetric key.

At self-action 354, LWS 202 can generate the second symmetric key K_SYM2. Also at self-action 354, LWS 202 also can store K_SYM2 in volatile memory in order to obtain a higher level of security for K_SYM2 because, again, host-entity 201 potentially presents a hostile environment toward LWS 202.

At self-action 356, LWS 202 can encrypt K_SYM2, and optionally any acknowledgement data (ACK_DATA) that might be associated with acknowledging the request for the communication session, according to K_SYM1, namely
E_{K}_{_{—}}_{SYM1}(K_SYM2, ACK_DATA) 10)

At action 358, LWS 202 can send (e.g., via communication services 204 and 170) an acknowledgement message to server 102. The encrypted versions of K_SYM2 and ACK_DATA can comprise at least a portion of the payload of the acknowledgement request. Alternatively, the acknowledgement request can omit the ACK_DATA, or can include the ACK_DATA albeit not encrypted according to K_SYM1. To reduce the degree to which a malefactor can sniff for the acknowledgement message of action 334, it can be sent using a connectionless protocol, e.g., UDP (user datagram protocol). At self-action 360, server 102 can decrypt K_SYM2 (and the ACK_DATA if present and encrypted) according to K_SYM1, namely
D_{K}_{_{—}}_{SYM1}(K_SYM2, ACK_DATA) 11)

At action 362, server 102 can initiate the second connection-oriented communication session using, e.g., TCP, with LWS 202 (e.g., via communication services 170 and 204). At action 364, server 102 and LWS 202 can securely exchange one or more messages whose payloads include various different instances of private data (PRIV_DATA), as part of the second session using TCP, similarly to action 340 of FIG. 3B.

After the one or more messages of action 364 are exchanged, server 102 can terminate the second session at action 366. Alternatively, the second TCP session can be terminated by LWS 202. Such an alternative is depicted in FIG. 3A via the line representing action 342 having an open-headed arrow

[symbol]

pointing to server 102 in addition to a solid-head arrow

[symbol]

pointing to LWS 202.

After the second TCP session is terminated, each of server 102 and LWS 202 should retain K_SYM1 for later use during the current spell, as indicated by self-actions 368A and 368B, respectively. After yet again not having discarded K_SYM1, each of server 102 and LWS 202 can then stay alive waiting for the next communication from the other (if that arises at all), as indicated by self-actions 370A and 370B. Like self-actions 320A & 320B, self-actions 368A & 368B and self-actions 370 & 370B can occur substantially simultaneously, etc., respectively.

A last circumstance to be discussed is re-registration. Suppose that a first spell ends, e.g., because LWS 202 is rebooted or shut down, or it loses power, etc. Recalling that LWS stores K_SYM1 in volatile memory, then K_SYM1 will be lost to LWS 202. Server 102 typically will not be aware that the first spell is over because it will not be aware of what has happened to LWS 202. Accordingly, LWS should generate a new K_SYM1 (let's call it K_SYM1′) for the new (second) spell. Generally, re-registration is similar to registration. A difference, however, between re-registration and the registration described above with reference to FIG. 3A is that LWS 202 will typically know its CE_ID in the former circumstance but not in the latter. In response to action 316, it should be recalled that LWS 202 already can have stored (in non-volatile memory) CE_ID and/or the version of CE_ID encrypted according to now-lost K_SYM1.

Accordingly, re-registration can proceed similarly to the registration described with respect to FIG. 3A, but can include the following differences. First, at message 306, the other data (again, O_DATA) can include the CE_ID or the version of CE_ID encrypted according to now-lost K_SYM1, namely
E_{K}_{_{—}}_{SYM1}(CE_ID) 12)
Inclusion of the CE_ID or E_{K}_{_{—}}_{SYM1}(CE_ID) in the payload of the message of action 306 can indicate to server 102 that the message is a re-registration request rather than an original registration request. In the payload, CE_ID can be encrypted according to K_PUB, or instead E_{K}_{_{SYM1}}(CE_ID) can be present without being encrypted according to K_PUB, etc.

A second difference of re-registration is that server 102 should not perform self-action 310 because LWS 202 has notified sever 102 (as discussed above) that it still has the CE_ID that was previously generated for it.

The discussion presented above has been couched in terms of a remediation system. It should be understood that embodiments of the present invention are also suited to any system for which it would be beneficial to employ a secure communication protocol that is less susceptible to a cracked public key than, e.g., is SSL.

The methodologies discussed above can be embodied on a machine-readable medium. Such a machine-readable medium can include code segments embodied thereon that, when read by a machine, cause the machine to perform the methodologies described above.

Of course, although several variances and example embodiments of the present invention are discussed herein, it is readily understood by those of ordinary skill in the art that various additional modifications may also be made to the present invention. Accordingly, the example embodiments discussed herein are not limiting of the present invention.

1. A method of establishing secure communication, the method comprising:
generating a first symmetric key;
encrypting at least the first symmetric key according to a public key;
sending a first message that includes at least the encrypted first symmetric key to a communication counterpart using a connectionless protocol; and
receiving, as part of a connection-oriented-protocol first session, a second message that includes an acknowledgement that the counterpart received the first message, the acknowledgement being encrypted via the first symmetric key.

2. The method of claim 1, further comprising:
letting the first session stop; and
keeping the first symmetric key available for use with a future second connection-oriented protocol session.

3. The method of claim 2, wherein the keeping available of the first symmetric key includes not deallocating volatile memory allocated thereto.

4. The method of claim 1, wherein the first session is stopped substantially immediately after receiving the second message.

5. The method of claim 1, wherein the sending of the first message includes using a connectionless protocol.

6. The method of claim 5, wherein:
the connectionless protocol is UDP (user datagram protocol); and
the first session uses TCP (transmission control protocol).

7. The method of claim 1, wherein the second message further includes an identification (ID) which the counterpart has assigned to the sender of the first message.

8. A method of establishing secure communication, the method comprising:
receiving a first message that was sent using a connectionless protocol from a communication counterpart,
the first message including at least a first symmetric key that has been encrypted according to a public key, there being a private key counterpart thereto;
decrypting the first message according to the private key to obtain at least the first symmetric key;
encrypting an acknowledgement of having received the first message according to the first symmetric key; and
sending, as part of a first connection-oriented-protocol session, a second message that includes the encrypted acknowledgement to the counterpart.

9. The method of claim 8, further comprising:
letting the first session stop; and
keeping the first symmetric key available for use with a future second connection-oriented protocol session.

10. The method of claim 9, wherein the keeping available of the first symmetric key includes not deallocating volatile memory allocated thereto.

11. The method of claim 8, wherein the first session is stopped substantially immediately after receiving the second message.

12. The method of claim 8, wherein the first message is sent according to a connectionless protocol.

13. The method of claim 12, wherein:
the connectionless protocol is UDP (user datagram protocol); and
the first session uses TCP (transmission control protocol).

14. The method of claim 8, further comprising:
assigning an identification (ID) to the counterpart;
wherein the second message further includes the ID.

15-31. (canceled)

32. A machine-readable medium comprising instructions, execution of which by a machine facilitates establishing secure communication, the machine-readable instructions including:
a first code segment to generate a first symmetric key;
a second code segment to encrypt at least the first symmetric key according to a public key;
a third code segment to send a first message that includes at least the encrypted first symmetric key to a communication counterpart using a connectionless protocol;
a fourth code segment to receive, as part of a connection-oriented-protocol first session, a second message that includes an acknowledgement that the counterpart received the first message,
the acknowledgement being encrypted via the first symmetric key.

33. The machine-readable instructions of claim 32, further comprising:
a fifth code segment to let the first session stop; and
a sixth code segment to keep the first symmetric key available for use with a future second connection-oriented protocol session by not deallocating volatile memory allocated to the first symmetric key.

34. A machine-readable medium comprising instructions, execution of which by a machine facilitates establishing secure communication, the machine-readable instructions including:
a first code segment to receive a first message that was sent using a connectionless protocol from a communication counterpart,
the first message including at least a first symmetric key that has been encrypted according to a public key, there being a private key counterpart thereto;
a second code segment to decrypt the first message according to the private key to obtain at least the first symmetric key;
a third code segment to encrypt an acknowledgement of having received the first message according to the first symmetric key; and
a fourth code segment to send, as part of a first connection-oriented-protocol session, a second message that includes the encrypted acknowledgement to the counterpart.

35. The machine-readable instructions of claim 34, further comprising:
a fifth code segment to let the first session stop; and
a sixth code segment to keep the first symmetric key available for use with a future second connection-oriented protocol session.

36-41. (canceled)

42. An apparatus for establishing secure communication, the apparatus comprising:
means for generating a first symmetric key;
means for encrypting at least the first symmetric key according to a public key;
means for sending a first message that includes at least the encrypted first symmetric key to a communication counterpart using a connectionless protocol;
and means for receiving, as part of a connection-oriented-protocol first session, a second message that includes an acknowledgement that the counterpart received the first message,
the acknowledgement being encrypted via the first symmetric key.

43. An apparatus for establishing secure communication, the apparatus comprising:
means for receiving a first message that was sent using a connectionless protocol from a communication counterpart,
the first message including at least a first symmetric key that has been encrypted according to a public key, there being a private key counterpart thereto;
means for decrypting the first message according to the private key to obtain at least the first symmetric key;
means for encrypting an acknowledgement of having received the first message according to the first symmetric key; and
means for sending, as part of a first connection-oriented-protocol session, a second message that includes the encrypted acknowledgement to the counterpart.

44. (canceled)

45. A machine configured to implement the method of claim 1.

46. A machine configured to implement the method of claim 8.

47. (canceled)
